(19) United States
(12) Patent Application Publication
(10) Pub. No.: US 2014/0218489 A1
(43) Pub. Date: Aug. 7, 2014

(54) TEST SIGNAL GENERATOR, TEST SIGNAL FOR 3D DISPLAY APPARATUSES, AND STORAGE MEDIUM HAVING A TEST SIGNAL STORED THEREON

(71) Applicants: Rainer Schäfer, Wolfersdorf (DE); Peter Tho Pesch, Munchen (DE)

(72) Inventors: Rainer Schäfer, Wolfersdorf (DE); Peter Tho Pesch, Munchen (DE)

(73) Assignee: INSTITUT FUR RUNDFUNKTECHNIK GMBH, Wolfersdorf (DE)

(21) Appl. No.: 14/233,495

(22) PCT Filed: Jul. 17, 2012
(86) PCT No.: PCT/EP2012/064034

§ 371 Date: Mar. 26, 2014

(30) Foreign Application Priority Data
Jul. 20, 2011 (IT) TO2011A000654

(51) Int. Cl. H04N 13/04; H04N 17/00

(52) U.S. Cl. CPC H04N 13/0425; H04N 17/004
USPC 348/51

(57) ABSTRACT

Some 3D video display apparatuses reproduce the two stereo channels in a temporally offset manner, which may bring about the occurrence of interfering image errors. Appropriate dispositions allow to compensate such image errors entirely or in part. In the reproduction of 3D video it is not definitely possible to recognize whether, and in what form, such dispositions are being employed in a display apparatus. The invention discloses a test signal generator and a test signal which allow to examine the error compensation dispositions being employed.

### INTRODUCTION

The invention relates to a test signal generator in accordance with the preamble of claim 1, a test signal obtained by means of the test signal generator, and a storage medium having a test signal stored thereon.

Nowadays there exist display apparatuses for 3D video where the two stereo channels are reproduced in a temporally offset manner, as is the case with the shutter technique. This temporal difference between the channels as a general rule brings about interfering image errors. With the aid of appropriate dispositions (in the following referred to as image error compensation) it is fundamentally possible to compensate these image errors entirely or in part. In normal image reproduction it is, however, not possible at all or only with great difficulty to positively determine whether image error compensation is being employed in the display apparatus.

The invention has the aim of proposing a solution allowing to ascertain more easily whether or not 3D display apparatuses have already been provided with an image error compensation.

To this end, the test signal generator of the invention is characterized in accordance with the characterizing portion of claim 1.

The test signal generated by the test signal generator and offered to the display apparatus and displayed on the display screen of the display apparatus allows the observer to clearly recognize this image error. The test signal generator and the test signal are based on the following inventive concept.

The technical cause for the image error occurring in display apparatuses including the shutter technique is as follows: In the display apparatuses concerned, the second image (as a rule the right one) is reproduced only after the first (left) image and thus at a wrong timing.

In other words, the reproduction timing of the right image does not match its reproduction position. As a result a moving object in the right image is not at the position that an observer would assume based on the object movement. The difference between the shown place and the place matching the object movement is discernible to the observer as a local offset of a moving object.

Due to this problem involved in the shutter technique, the observer of moving objects experiences two kinds of image errors. On the one hand, annoying jerking of images may occur in the objects. On the other hand, the local offset has an effect on the perceived object depth. The image errors coming about in typical 3D scenes can, however, not definitely be ascribed to the shutter technique and for this reason can not be made use of directly for an evaluation of the display apparatus. Namely, jerky images may also be due to other causes such as the film judder known from technical literature. Although the altered perception of depth may in turn definitely be associated to the shutter technique, which means that it is not brought about by other causes, the observer nevertheless is not definitely capable of recognizing that the object perceived by him is situated in a wrong plane of depth. “Wrong” in this context has the meaning that the perceived object depth is influenced by the shutter technique. The error comes about when jerking images are erroneously interpreted by the eye to be depth information, which may be ascertained with particular clarity with movements in a horizontal direction. However the observer lacks a definite reference point for the perceived depth in order to evaluate the display apparatus with the aid of the object depth. Nevertheless the effect is suited as a basis for isolating the image errors brought about by the shutter technique and making them clearly visible to the observer.

To this end, a signal is generated in the testing apparatus, which makes use of the perceived depth of the displayed image as an indication for the evaluation and references a reference point for the impression of depth. The following properties of the test signal generated by the test generator result in test images on the display screen that are characterized as follows:
The test image contains one or several moving objects reciprocating along a curve, preferably in a horizontal direction.
The moving object(s)s preferably move(s) within the plane of the display screen.

Moving objects, preferably ones moving in a horizontal direction, generate the error in perception of depth that is required for an evaluation. This allows to evaluate the perceived object depth in the test image which is known to the observer. One example elucidates the underlying principle:

In the test image a moving object (e.g., a rectangular or circular one) is positioned in the plane of the display screen. The object moves from left to right and again to the left. When reproduced correctly by the display apparatus, the object moves in the plane of the display screen and the observer will note that the object is moving in the plane of the display screen.

In a display apparatus without image movement compensation the observer will perceive the object in front or to the rear of the plane of the display screen.

When the object is thus situated in the plane of the display screen, error-compensating dispositions are accordingly being carried out by the display apparatus, for in the absence of such dispositions the object would be perceived in front or to the rear of the plane of the display owing to the shutter technique.

### SHORT DESCRIPTION OF THE FIGURES

The invention shall be explained in more detail by referring to the following figures, showing in:

FIG. 1 a schematic representation of the testing apparatus in accordance with the main claim,

FIG. 2 by way of example a test image which is reproduced on the display apparatus and evaluated by the observer,

FIG. 3 the display on a display screen in a first embodiment, and

FIG. 4 the display on a display screen in a second embodiment.

### DESCRIPTION OF THE FIGURES

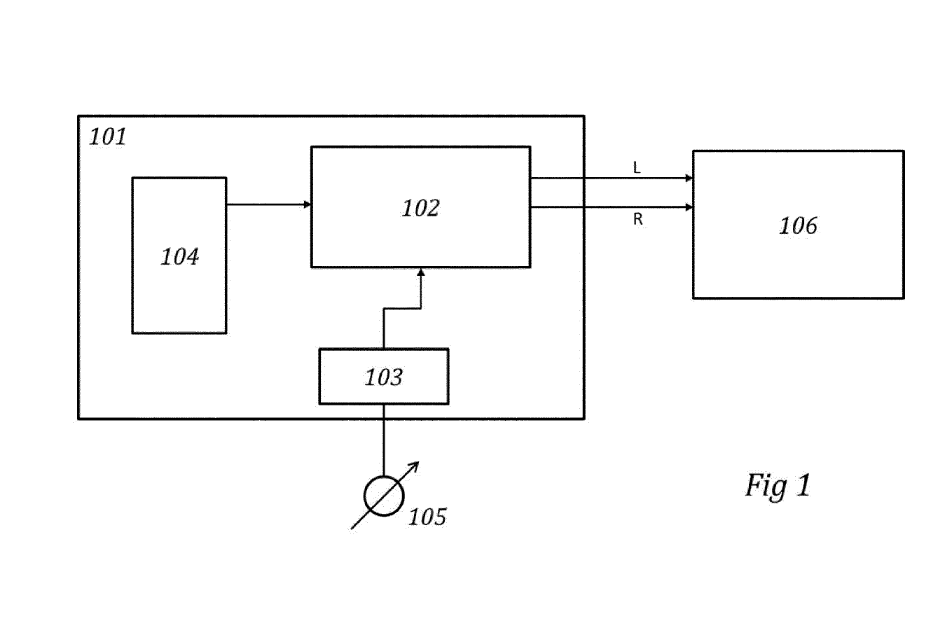

FIG. 1 schematically shows the operation of a test generator 101 in accordance with the invention. The test generator is provided with an image generator 102 which generates test signals having the form of stereo images. The test generator contains a control unit 103 and a setting faculty 105 allowing to set parameters for the image generation of the test image.

In another embodiment it was possible (in a given case additionally) to access a stock of data 104 of pre-produced images in the generation of the test images.

The generated test signals are sent to the display apparatus 106 to be tested and evaluated there.

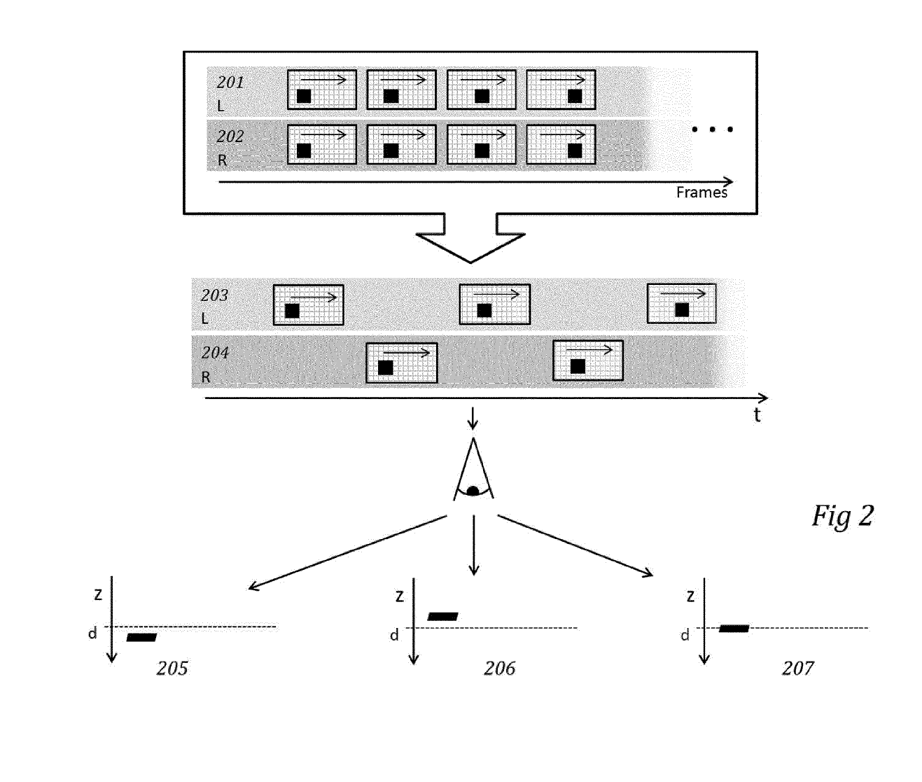

FIG. 2 by way of example shows the performance of a test with the aid of the test generator. The test generator initially generates a sequence of images with a right and a left channel (201 and 202). For the reproduction on the display apparatus the stereo channels are reproduced in a temporally offset manner (203 and 204) by reproducing the images of the one channel (as a rule the right one) after the respective images of the other channel. On the display apparatus the observer can perceive one from among three cases (205-207) whereby he is enabled to evaluate the display apparatus in terms of image error compensation. In the three diagrams the spatial depth is plotted on the z axis. The dashed line (d) designates the plane of the display screen. There are three possibilities for the perceived depth of the rectangle:

1. The object (in the present case a rectangle) appears to the rear of the plane of the display screen 205 when the object moves in the one direction. In this case the image error is not compensated at all or only partly by the display apparatus.
2. The rectangle appears in front of the plane of the display screen 206 upon movement in the other direction. In this case, as well, the image error is not compensated at all or only partly.
3. The rectangle appears precisely in the plane of the display screen 207. In this case image error compensations are performed by the display apparatus.

In cases 1 and 2, i.e. upon occurrence of an image error, there additionally results the possibility of recognizing which one of the right and left images of a pair of images (UR) is displayed first by the display apparatus.

When the object moves from left to right, the eye is conveyed the impression that in the temporally offset channel the object has shifted to the left in the image. In a case where the left channel is displayed first and the right channel in a temporally offset manner, with the object thus having shifted to the left in the right image, the image appears in front of the plane of the display screen. In a case where the right channel is displayed first and the left channel in a temporally offset manner, with the object thus having shifted to the left in the left image, the image appears to the rear of the plane of the display screen.

Evaluation may optionally be facilitated further through additional properties of the test signal:
The moving objects should change direction in the testing sequence
Two objects moving in opposite directions should be visible
The movement should be restricted to a purely horizontal movement

The movement should not be too slow as the effect becomes more pronounced with an increasing velocity of the object.

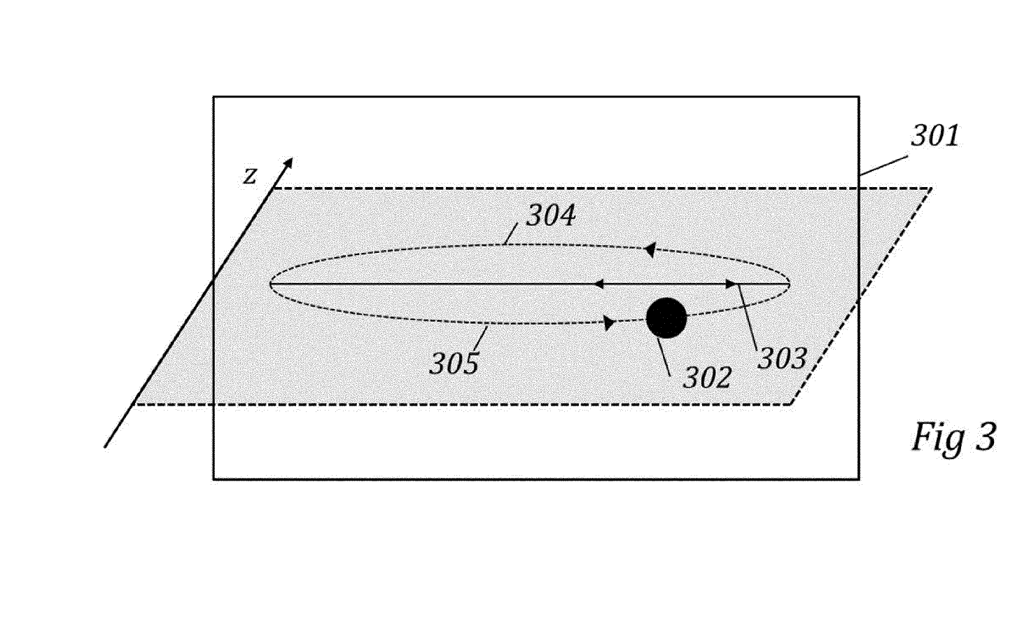

FIG. 3 shows an embodiment of a test image visually displayed on a display screen 301. It contains a circular object which reciprocates along a curve 303, in the present case a straight horizontal curve, wherein it shall be assumed that the display apparatus is provided with movement compensation. In the absence of movement compensation an observer will perceive the object to the rear of the display screen when moving in the one direction, cf. reference numeral 304, and in front of the display screen when moving in the opposite direction, cf. reference numeral 305. What is thus created is a circular movement within a two-dimensional area through the line z, perpendicularly to the plane of the display screen.

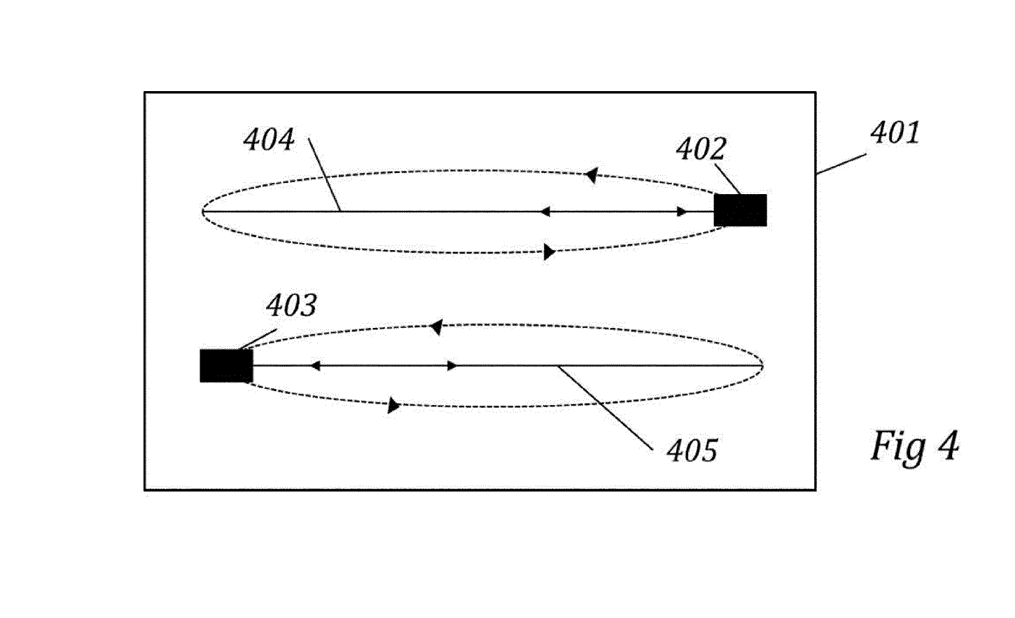

FIG. 4 shows a second embodiment of a test image visually displayed on a display screen 401. It contains two rectangular objects 402, 403 performing a reciprocating movement along curves 404 and 405, in the present case straight horizontal curves. In the absence of movement compensation an observer will perceive the objects to the rear of the display screen in the one direction and in front of the display screen when moving in the opposite direction.

The test signal as such might also be stored on a storage medium such as a CD ROM disc or a USB stick and offered to an owner of a reader device of such a storage medium. The user may then connect the reader device to the display apparatus to be tested, and test this apparatus.

It should be noted that the invention is not restricted to the shown embodiments. The invention also relates to minor modifications of the test signal generator and of the test signal, respectively. Thus, the movement may take place in random directions. Despite the fact that detection is easiest in the horizontal direction, a movement in the vertical direction, for instance, is equally possible.

1. A test signal generator for generating a test signal intended to be reproduced on a display screen of a 3D display apparatus for displaying 3D image signals, wherein the test signal, when generated, corresponds to a recording signal of a 3D recording of an object which repeatedly performs reciprocating movements along a predetermined curve.

2. The test signal generator of claim 1, wherein the predetermined curve is a straight curve.

3. The test signal generator of claim 2, wherein the predetermined curve is a horizontal curve.

4. The test signal generator of claim 1, wherein the object represents a rectangular or circular object.

5. The test signal generator of claim 1, wherein the object exhibits sharply outlined contours.

6. The test signal generator of claim 1, wherein the object has a color which is different from the background color.

7. The test signal generator of claim 1, wherein the test signal, when generated, corresponds to a recording signal of a 3D recording of at least two objects wherein the second object repeatedly performs reciprocating movements along a second predetermined curve which extends in parallel with the former curve, however in directions opposite to those of the first object.

8. A test signal generated by the test signal generator as claimed in claim 1.

9. A storage medium having a test signal of claim 8 stored thereon.
